(19) United States
(12) Patent Application Publication
(10) Pub. No.: US 2023/0193938 A1
(43) Pub. Date: Jun. 22, 2023

(54) Clean Room Retaining Pin

(71) Applicant: Raytheon Company, Waltham, MA (US)

(72) Inventors: Brent Carper, Tucson, AZ (US); Eric P. Huelsmann, Tucson, AZ (US)

(21) Appl. No.: 17/555,033

(22) Filed: Dec. 17, 2021

(51) Int. Cl. F16B 19/00

(52) U.S. Cl. CPC F16B 19/00

(57) ABSTRACT

Described herein is a retaining pin comprising a tubular outer shaft and a rotatable shaft disposed within the tubular outer shaft. The rotatable shaft is rotatably engaged with the tubular outer shaft. The rotatable shaft can comprise a locking protrusion fixed to an end of the rotatable shaft and that is operable to rotate with rotation of the rotatable shaft. An axis of the tubular outer shaft and an axis of the rotatable shaft are eccentric.

### BACKGROUND

Quick-release retaining pins are often used in multiple environments and applications including manufacturing and tooling applications, as well as in assembling and operating machinery. Commercial off the shelf retaining pins currently in use include quick-release ball lock pins and others that are used to attach machine parts together. Currently-available retaining pins do not adequately meet Foreign Object Debris (“FOD”) requirements. Accordingly, commercially available retaining pins are not well-suited for use in a clean room or other environment where cleanliness is of concern for particular manufacturing/tooling machines or processes. In manufacturing situations where cleanliness is of importance, particulate contamination can lead to hardware failure, quality defects, costly and extensive repairing and rebuilding of machines, and/or other undesirable side effects in manufacturing and assembling of parts. Accordingly, solutions and improvements for retaining pins to adapt to use in multiple environments continues to be an ongoing field of research and engineering.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 illustrates an isometric view of a retaining pin in accordance with an example of the present disclosure.

FIG. 2 illustrates a cross-sectional side view of the retaining pin of FIG. 1.

FIGS. 3a and 3b, respectively, illustrate a front view and an end view of the retaining pin of FIG. 1, where the retaining pin is shown in an unlocked state.

FIGS. 3c and 3d, respectively, illustrate a front view and an end view of the retaining pin of FIG. 1, where the retaining pin is shown in a locked state.

FIGS. 4a and 4b, respectively, illustrate a front view and an internal view of a retaining pin in accordance with an example of the present disclosure.

FIG. 5 illustrates various stages of locking and unlocking the retaining pin of FIG. 4a.

FIG. 6a illustrates a front view of some of the components of the retaining pin of FIG. 4a.

FIG. 6b illustrates an isometric view of some of the components of the retaining pin of FIG. 4a.

FIGS. 7a-7d illustrate the retaining pin of FIG. 1 in use as retaining together various pieces of a structure.

FIGS. 8a-8b illustrate various components of the retaining pin of FIG. 4a

FIG. 8c illustrates the positioning or clocking spring of the retaining pin of FIG. 4a in various stages as coupled with the rotatable shaft of the retaining pin.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness can in some cases depend on the specific context. However, generally speaking, the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” can be either abutting or connected. Such elements can also be near or close to each other without necessarily contacting each other. The exact degree of proximity can in some cases depend on the specific context.

An initial overview of the inventive concepts are provided below and then specific examples are described in further detail later. This initial summary is intended to aid readers in understanding the examples more quickly, but is not intended to identify key features or essential features of the examples, nor is it intended to limit the scope of the claimed subject matter.

Disclosed herein is a retaining pin for coupling various structures or structural elements to each other. The retaining pin can comprise a tubular outer shaft and a rotatable shaft. The rotatable shaft can be disposed within the tubular outer shaft and rotatably engaged with the tubular outer shaft. The rotatable shaft can comprise a locking protrusion fixed to an end of the rotatable shaft and that is operable to rotate with rotation of the rotatable shaft. An axis of the tubular outer shaft and an axis of the rotatable shaft can be eccentric (i.e., offset from one another).

Also disclosed herein is a method for configuring a retaining pin. The method can comprise configuring the retaining pin to comprise a tubular outer shaft. The method can further comprise configuring the retaining pin to comprise a rotatable shaft disposed within the tubular outer shaft and rotatably engaged with the tubular outer shaft. The rotatable shaft can comprise a locking protrusion fixed to an end of the rotatable shaft and that is operable to rotate with rotation of the rotatable shaft. An axis of the tubular outer shaft and an axis of the rotatable shaft can be eccentric.

Further disclosed herein is a system including structure or structural elements to be coupled together. The system can comprise a first structure comprising a hole formed through the first structure. The system can further comprise a second structure comprising a hole formed through the second structure. The system can further comprise a retaining pin comprising a tubular outer shaft and a rotatable shaft disposed within the tubular outer shaft. The rotatable shaft can be rotatably engaged with the tubular outer shaft. The rotatable shaft can comprise a locking protrusion fixed to an end of the rotatable shaft and that is operable to rotate with rotation of the rotatable shaft. An axis of the tubular outer shaft and an axis of the rotatable shaft can be eccentric, and the locking protrusion can be eccentric with the axis of the rotatable shaft. The first structure is configured to be coupled to the second structure by the retaining pin being inserted through the hole of the first structure and the hole of the second structure, and the retaining pin actuated. The retaining pin can be locked in place and hold the first and second structures together via the locking protrusion. In one example, the locking protrusion can be planar and configured to engage with a surface of one or more of the first structure and the second structure. However, this is not intended to be limiting in any way as the locking protrusion can comprise any size, shape, or configuration.

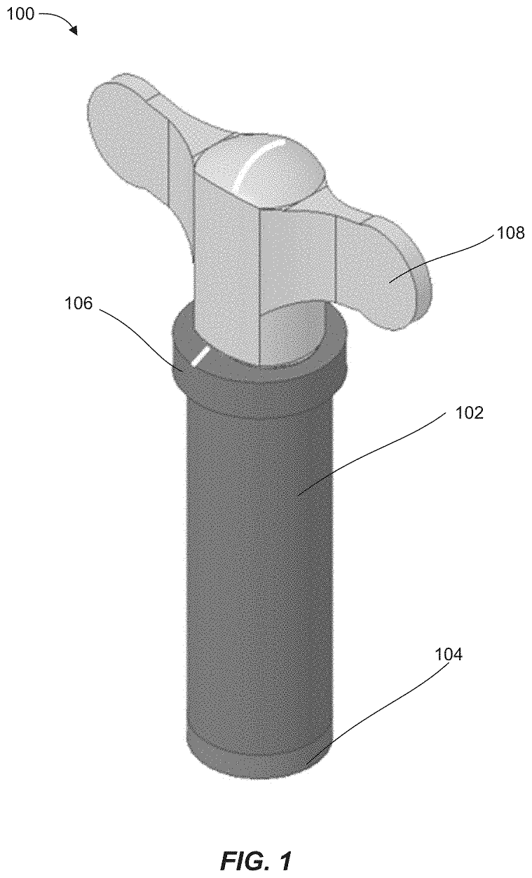

To further describe the present technology, examples are now provided with reference to the figures. With reference to FIG. 1, illustrated is a retaining pin 100 in accordance with an example of the present disclosure. Retaining pin 100 can comprise a tubular outer shaft 102. Tubular outer shaft 102 can comprise a tubular hollow member of any cross-sectional shape or configuration, whether cylindrical, cubic, cuboid, triangular prism, hexagonal prism, any polygon prism, or any other possible shapes or configurations with an outer wall defining an inner bore or cavity. Tubular outer shaft 102 can receive and house a rotatable shaft that supports a locking protrusion 104. Tubular outer shaft 102 can further comprise a shoulder 106 having a greater diameter and perimeter and footprint than an outer surface of tubular outer shaft 102 adjacent the shoulder 106. Furthermore, retaining pin 100 can comprise a rotatable handle 108 fixed to the rotatable shaft that supports locking protrusion 104. Rotation of rotatable handle 108 can be configured to rotate rotatable shaft and locking protrusion 104. As illustrated herein, locking protrusion 104 can be configured as a disk having various surfaces (these can be planar or any other configuration), however, this is not intended to be limited in any way. Indeed, the locking protrusion 104 can comprise any size, shape or configuration.

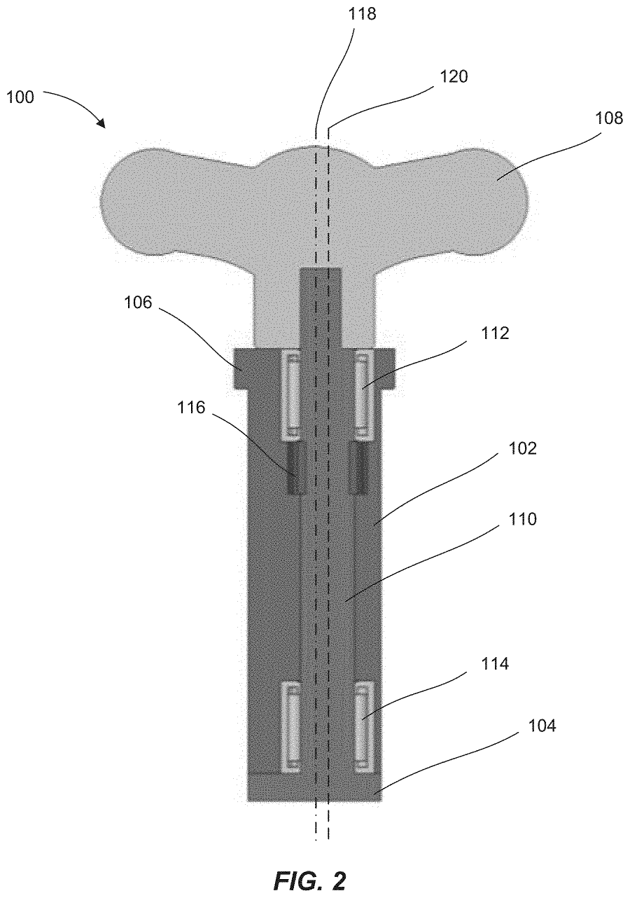

FIG. 2 illustrates a cross-sectional side view of retaining pin 100. As shown, a rotatable shaft 110 is disposed within tubular outer shaft 102. Rotatable shaft 110 is rotatably engaged with tubular outer shaft 102, such that tubular outer shaft 102 and rotatable shaft 110 are rotatable relative to one another. To facilitate rotation of rotatable shaft 110 relative to tubular outer shaft 102, retaining pin 100 can comprise roller bearings to facilitate more efficient rotation of rotatable shaft 110. For example, retaining pin 100 can comprise a roller bearing 112 supported by tubular outer shaft 102 at a first end (e.g., at a top opening) of tubular outer shaft 102 and that is rotatably engaged with rotatable shaft 110. Furthermore, retaining pin 100 can comprise a roller bearing 114 supported by tubular outer shaft 102 at a second end (e.g., at a bottom opening) of tubular outer shaft 102 and that is rotatably engaged with rotatable shaft 110. Retaining pin 100 can further comprise a positioning spring 116 in the form of a clocking spring.

For purposes of using the retaining pins as disclosed herein in clean rooms or other situations where foreign object debris is undesirable, roller bearings 112 and 114 can be sealed roller bearings. Sealed roller bearings ensure that no debris, particles, fragments, or other matter from the roller bearings are released to the outside environment to avoid foreign object damage to any parts or machinery in the environment. Furthermore, placing sealed roller bearings 112 and 114 at opposite ends of tubular outer shaft 102 operates to seal all inner workings of retaining pin 100 within tubular outer shaft 102, thereby confining all foreign object debris within tubular outer shaft 102 and ensuring that minimal to no foreign object debris can enter the outside environment from retaining pin 100. The sealed roller bearings further keep outside debris from entering retaining pin 100. Accordingly, retaining pins according to examples described herein can be suitable for use in clean room environments without possibilities of introducing foreign object debris into the clean room.

As shown in FIG. 2, tubular outer shaft 102 comprises a central axis 118 substantially concentric with a center or central axis of retaining pin 100. Rotatable shaft 110 also comprises a central axis 120. As illustrated, central axis 120 of rotatable shaft 110 is non-concentric with respect to, or in other words is eccentric with respect to or offset from, central axis 118 of tubular outer shaft 118. Accordingly, rotatable shaft 110 rotates about an axis that is offset from an axis 118 of the retaining pin 100 and/or tubular outer shaft 102.

As further illustrated in FIG. 2, axis 120 of rotatable shaft 110 is also eccentric such that it is offset from a center of locking protrusion 104, which center is substantially aligned with axis 118 in the configuration of retaining pin 100 shown in FIG. 2. Accordingly, locking protrusion 104 is eccentric with the axis 120 of rotatable shaft 110 such that locking protrusion 104 rotates eccentrically with respect to rotatable shaft 110 and tubular outer shaft 102 as rotatable shaft 110 is rotated by handle 108 with respect to tubular outer shaft 102.

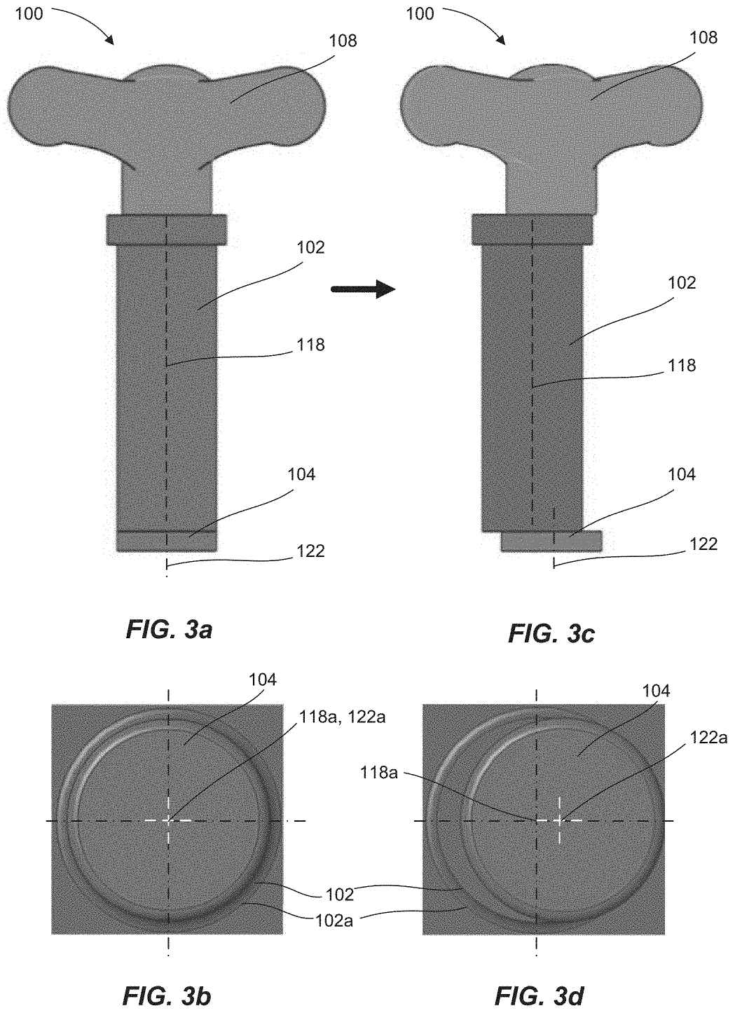

Eccentric rotation of locking protrusion 104 is illustrated and described further in FIGS. 3a-3d. FIG. 3a illustrates retaining pin 100 in an unlocked state. FIG. 3b illustrates an end view of retaining pin 100 viewed from the end where locking protrusion 104 is disposed on retaining pin 100. As shown in FIGS. 3a and 3b, in the unlocked state, locking protrusion 104 (e.g., a disk) is substantially concentric and in alignment with tubular outer shaft 102. In other words, an axis center 122a of locking protrusion 104 is aligned with axis center 118a of tubular outer shaft 102. With retaining pin 100 in the unlocked state, locking protrusion 104 is substantially disposed within the boundaries of an outer surface 102a of tubular outer shaft 102. Such configuration allows retaining pin 100, in the unlocked state, to be easily inserted into and/or through holes formed in structures to be coupled together and secured via retaining pin 100.

FIG. 3c illustrates retaining pin 100 in a locked state. To transition retaining pin 100 from the unlocked state (FIGS. 3a and 3b) to the locked state (FIGS. 3c and 3d) rotating handle 108 can be rotated a predetermined angle of rotation to rotate rotatable shaft 110 to the predetermined angle, thereby rotating locking protrusion 104 with rotatable shaft 110. As shown in FIG. 3c, in the locked state, locking protrusion 104, due to eccentric placement on rotatable shaft 110, is rotated to a placement where locking protrusion 104 (e.g., the disk) is eccentric with respect to tubular outer shaft 102, such that at least a portion of locking protrusion 104 extends beyond or protrudes from or overhangs an outer surface of the tubular outer shaft 102. In other words, an axis center 122a of locking protrusion 104 is offset with axis center 118a of tubular outer shaft 102 in the locked state. Indeed, with retaining pin 100 in the locked state, locking protrusion 104 is positioned so that it is disposed eccentrically with respect to the boundaries of an outer surface 102a of tubular outer shaft 102 such that at least a portion of locking protrusion is disposed outside of outer surface 102a of tubular outer shaft 102. In such configuration in the locked state, locking protrusion 104 can interface and engage with a surface of a structure through which retaining pin 100 is inserted to hold structures together and ensure that retaining pin 100 remains in place.

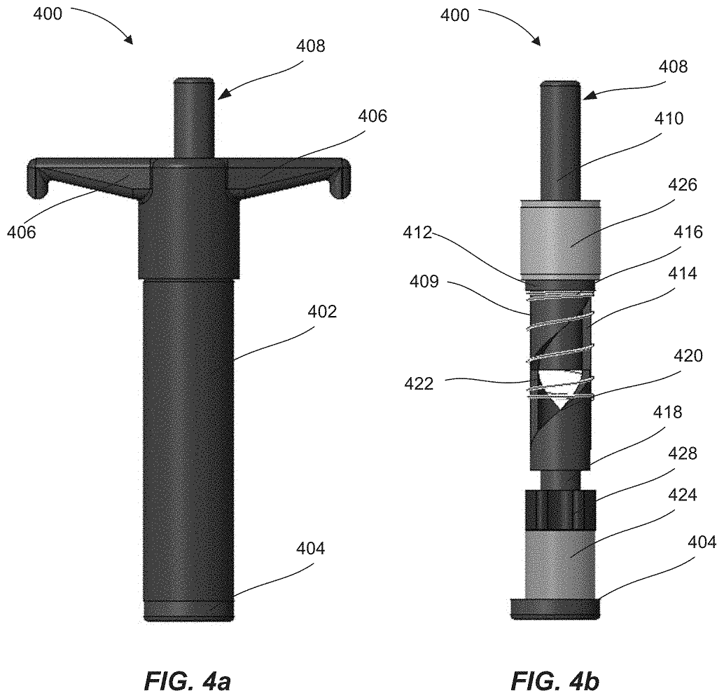

FIGS. 4a and 4b illustrate a retaining pin 400 in accordance with an example of the present disclosure. FIG. 4a illustrates retaining pin 400, which can include a tubular outer shaft 402 and a locking protrusion 404. Tubular outer shaft 402 can comprise a handle in the form of grip extensions 406 configured to be gripped by a user during operation of retaining pin 400 to facilitate operation of the retaining pin 400 as described below.

Retaining pin 400 can further comprise a plunger 408 having a plunger shaft 409 and a user interface portion in the form of a plunger barrel 410, the plunger 408 being operable to be received and moveable within tubular outer shaft 402. Plunger shaft 409 can further comprise shoulder 412 and one or more cam surfaces 414 disposed at an engagement end of plunger shaft 409 that is opposite the end where plunger barrel 410 is disposed. Plunger shaft 409 can be spring-loaded with spring 416. Spring 416 can engage with and be seated against shoulder 412 of plunger shaft 409 to bias plunger 408 upward with respect to tubular outer shaft 402.

Retaining pin 400 can further comprise a rotating shaft 418 that supports locking protrusion 404. Rotating shaft 418 can further comprise one or more follower surfaces 420 and 422 configured to engage and interface with cam surfaces 414 of plunger shaft 409. Cam surfaces 414 of plunger shaft 409 can be configured to interface with follower surfaces 420 and 422 of rotatable shaft 418 in such a way that depression of the plunger 408 by pressing plunger barrel 410 causes plunger shaft 409 to move downward in a linear motion and to contact and engage with follower surface 420.

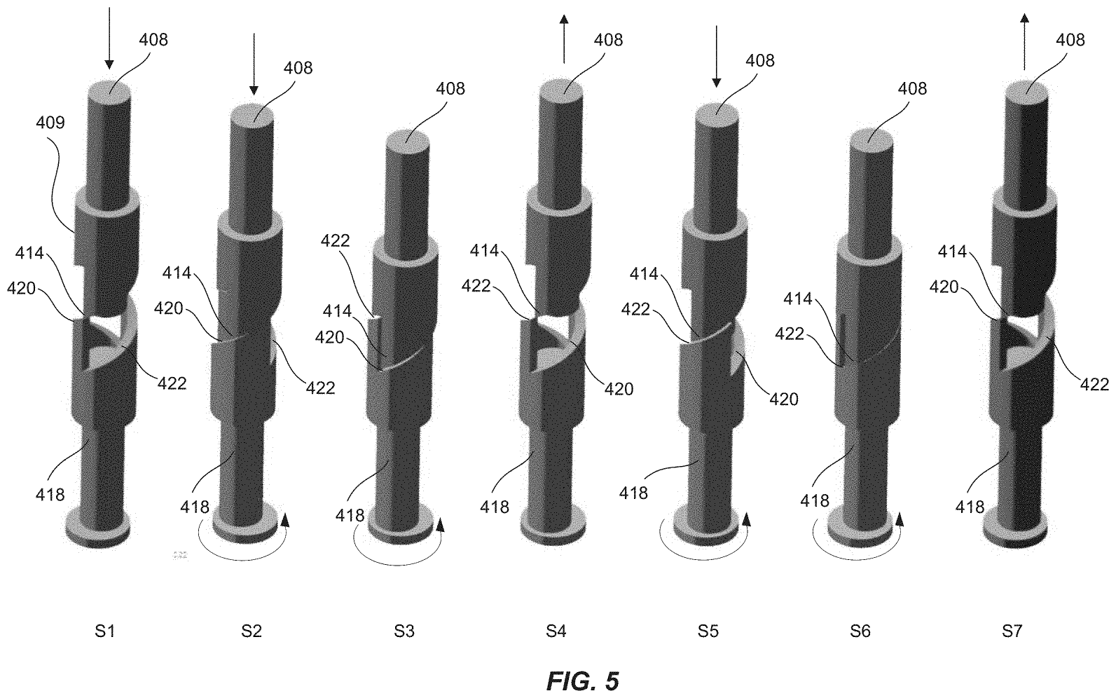

As shown, cam surfaces 414 and follower surfaces 420 and 422 can be helically-angled surfaces that engage with each other as plunger 408 is depressed. Rotational movement of rotatable shaft 418 due to depression of plunger 408 will be described in further detail below with reference to FIG. 5.

FIG. 4b further illustrates that retaining pin 400 can further comprise roller bearings 424 and 426. Roller bearing 424 can rotatably support rotatable shaft 418. Roller bearing 426 can support plunger shaft 409. Retaining pin 400 can further comprise a positioning spring 428 similar to positioning spring 116 in retaining pin 100, as discussed above. Similar to retaining pin 100, roller bearings 424 and 426 can be sealed roller bearings to prevent foreign object damage and debris from being in an outside environment.

FIG. 5 illustrates various exemplary stages of rotation of rotatable shaft 418 as plunger 408 is depressed and released. For clarity, all elements of retaining pin 400 have been omitted in FIG. 5 except for rotatable shaft 418 and plunger 408. With reference to FIGS. 4a and 4b, and as shown in stage S1 of FIG. 5, plunger 408 is fully extended and caused to be away from rotatable shaft 418, such that plunger shaft 409 and rotatable shaft 418 are out of contact with one another. A force depressing plunger 408 causes plunger shaft 409 to move towards rotatable shaft 418 to compress spring 416, which causes a helically angled first cam surface 414 of plunger shaft 409 to contact and engage a helically angled first follower surface 420 of rotatable shaft 418.

As plunger 408 is further depressed, upon cam surface 414 contacting and engaging first follower surface 420, sliding of first follower surface 420 along first cam surface 414 causes rotatable shaft 418 to rotate relative to plunger shaft 409. Stage S2 illustrates rotatable shaft 418 in mid-rotation as plunger shaft 408 is pressed downward into rotatable shaft 418. As the force continues to be exerted on plunger 408, rotatable shaft 418 continues to rotate until reaching stage S3 in which plunger 408 has completed a rotation of a predetermined angle (e.g., 180 degrees as shown in FIG. 5) in accordance with the design and configuration of the cam surface 414 and the follower surface 420. At stage S4, the force acting on plunger 408 is released, wherein spring 416 exerts an upward force on plunger 408 to cause plunger shaft 409 to move away from rotatable shaft 418 (e.g., by force of spring 416), such that the plunger shaft 408 is disengaged from the rotatable shaft 418. It will be appreciated from FIG. 5 that, at this stage (from S1-S4) locking protrusion 404 has been rotated by 180 degrees. Said rotation, caused by a single press of plunger 408, moves locking protrusion 404 from the unlocked state to the locked state similar to that shown for locking protrusion 104 or retaining pin 100 in FIGS. 3a-3d.

At this stage plunger 408 can again be pressed downward to cause plunger shaft 409 to engage with rotatable shaft 418 and to have cam surface 414 contact second follower surface 422, which has been moved into position by virtue of the rotation of the rotatable shaft 418 during stages S1-S4. In order to avoid cam surface 414 from sliding back into contact with the already-rotated first follower surface 420, rotatable shaft 418 can be biased (e.g., by positioning spring 428 or other springs) to position at least a portion of second follower surface 422 beneath and aligned with a tip of cam surface 414 at stage S4. This configuration ensures that, upon a subsequent press of plunger 408 downward towards rotatable shaft 418, cam surface 414 contacts the correct follower surface 422 to cause further rotation of rotatable shaft 418.

Stage S5 illustrates rotatable shaft 418 in mid-rotation as plunger 408 is pressed downward to cause plunger shaft 409 to engage rotatable shaft 418 with cam surface 414 contacting second follower surface 422. As the force continues to be exerted on plunger 408, rotatable shaft 418 continues to rotate until reaching stage S6 in which plunger 408 has completed a rotation of a predetermined angle (e.g., another 180 degrees as shown in FIG. 5) in accordance with the design and configuration of the cam surface 414 and the follower surface 422. At stage S7, the force acting on plunger 408 is released, wherein spring 416 exerts an upward force on plunger 408 to cause plunger shaft 409 to move away from rotatable shaft 418 (e.g., by force of spring 416), such that plunger shaft 409 is disengaged from the rotatable shaft 418. It will be appreciated from FIG. 5 that, at this stage (from S4-S7) locking protrusion 404 has been rotated another 180 degrees. Said rotation, caused by a single press of plunger 408, moves the locking protrusion from the locked state to the unlocked state similar to that shown for locking protrusion 104 in FIGS. 3a-3d. Through stages S1-S7, it can be seen that locking protrusion 404 completes 360 degrees rotation.

Similar to as explained before, in order to avoid cam surface 414 from sliding back into contact with the already-rotated second follower surface 422, rotatable shaft 418 can be biased (e.g., by positioning spring 428 or other springs) to position at least a portion of first follower surface 420 beneath a tip of cam surface 414 to ensure that, upon a subsequent press of plunger 408 downward towards rotatable shaft 418, cam surface 414 of plunger shaft 409 contacts the correct follower surface of 420 and 422 to cause further rotation of rotatable shaft 418 rather than repeated stationary engagement between rotatable shaft 418 and plunger shaft 408. In other words, rotatable shaft 418 and positioning spring 428, as interfaced with rotatable shaft 418, can be configured to induce rotation of the rotatable shaft 418 to a proper position, with plunger shaft 409 disengaged from rotatable shaft 418, to ensure that plunger 408, upon being depressed, will engage the different follower surfaces to effectuate rotation of rotatable shaft 418 relative to plunger 408. This clocking function can be configured to occur each time plunger shaft 408 becomes disengaged from rotatable shaft 418.

Retaining pin 400 illustrates a configuration in which plunger shaft 408 and rotatable shaft 418 each comprise two helically angled (cam or follower) surfaces that extend 180 degrees or less than 180 degrees around the shafts. This results in a rotation of 180 degrees or less than 180 degrees, respectively, of rotatable shaft 418 with every depression of plunger 408. Indeed, the cam and follower surfaces can be configured, such that full depression of plunger 408 causes rotation of rotatable shaft 418 a given number of rotational degrees to be in an intermediate angular orientation or position between clocked positions (i.e., a clocked position being an angular position or orientation of the rotatable shaft 418 with positioning spring 428 in a least flexed state (e.g., corresponding to a locked or unlocked state of the retaining pin 400)), wherein positioning spring 428 is caused to transition from a least flexed state in a current clocked position of rotatable shaft 418, through its maximum flexed state, and to an intermediate partially flexed state prior to a subsequent clocked position of rotatable shaft 418. The intermediate angular orientation of rotatable shaft 418 and the intermediate partially flexed state of positioning spring 428 can be such that positioning spring 428 induces a further (i.e., same direction) rotation of rotatable shaft 418 due to forces acting on rotatable shaft 418 from positioning spring 428 once plunger shaft 409 is disengaged from rotatable shaft 418. With the positioning spring 428 in this intermediate partially flexed state (beyond a maximum flexed state), and rotatable shaft 418 in such an intermediate angular orientation between clocked positions, release of the plunger shaft 408 and disengagement of the cam and follower surfaces can cause the positioning spring 428 to induce further same direction rotation of rotatable shaft 418 to the subsequent clocked position of rotatable shaft 418 due to the spring forces acting on rotatable shaft 418 and the configuration of detent features formed therein (as discussed in more detail below) without further actuation by plunger shaft 408. The intermediate angular orientation of rotatable shaft 418 that must be achieved to permit positioning spring 428 to be capable of inducing further same direction rotation of rotatably shaft 418 can vary depending upon the configuration of retaining pin 400.

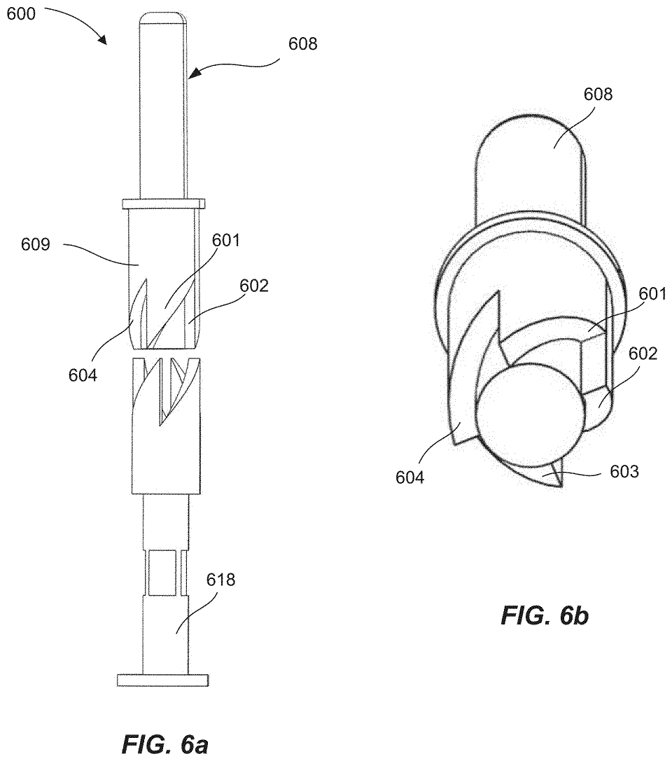

Retaining pin 400 can be alternatively configured in order that a single depression of plunger 408 causes any desired angle of rotation of rotatable shaft 418. As such, the design and configuration discussed herein where depression of plunger 408 results in 180 degrees of rotation of rotating shaft 418 is not intended to be limiting in any way. For example, FIGS. 6a and 6b illustrate a plunger shaft 609 and rotatable shaft 618 for a retaining pin 600 (not shown in its entirety, but similar in configuration and function to the retaining pin 400 discussed above) with the difference being that plunger shaft 608 can comprise four helically angled cam surfaces 601, 602, 603, and 604, and rotatable shaft 618 can comprise four follower surfaces 621, 622, 623, and 624 each corresponding to one of the cam surfaces 601, 602, 603, and 604 of plunger shaft 608. Follower surfaces 621, 622, 623, and 624 and cam surfaces 601, 602, 603, and 604 extend 90 degrees around their respective shafts. Accordingly, in the configuration of retaining pin 600, a single press and release of plunger 608 causes a rotation of 90 degrees of rotatable shaft 618. Therefore, four depressions of plunger 608 causes one full 360-degree rotation of rotatable shaft 618, with a positioning spring (not shown) being configured to clock the rotatable shaft 618 in a plurality of clocked positions in a similar manner as discussed herein.

Other angles and configurations are possible and contemplated herein. Indeed, any number of cam and/or follower surfaces can be used to configure a desired rotation of the rotatable shaft. (e.g., three equally spaced surfaces for 120-degree rotation per press, five surfaces for 72-degree rotation per press, and so forth). Additionally, the disclosure is not limited to equal rotation per press of the plunger. The cam/follower surfaces can have different lengths and sizes from each other so that each press of the plunger results in a different degree of rotation. Moreover, as discussed herein, the cam and follower surfaces can be configured to rotate the rotatable shaft a given number of degrees where the positioning spring transitions from a least flexed state and through a maximum flexed state and where the rotatable shaft is in a position where the positioning spring is capable of inducing further rotation of the rotatable shaft to the next clocked position due to the spring forces acting on the rotatable shaft upon release of the plunger shaft and disengagement of the current alignment of cam and follower surfaces.

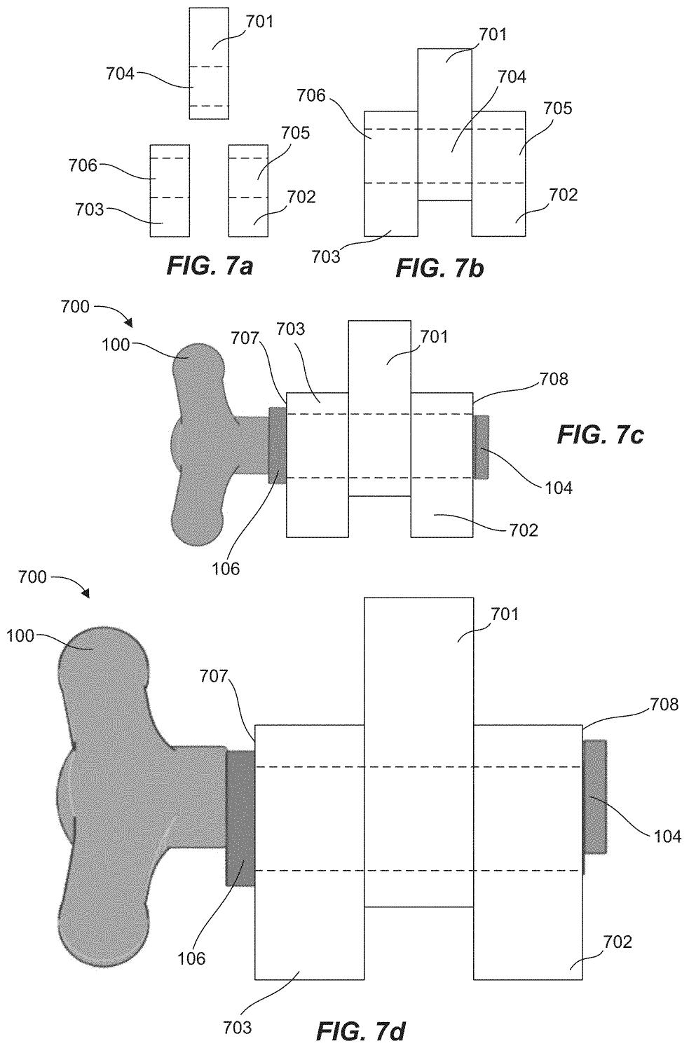

FIGS. 7a-7d illustrate an example of a system 700 comprising a retaining pin coupling various elements together. Retaining pins can be used in any number of applications including locking clamps, locking adjustable structures in place, retaining elements in machinery and so forth. FIG. 7a illustrates a plurality of cuboid structures separated from each other, these being exemplary structures to illustrate how various structural elements can be joined together by a retaining pin as disclosed herein. Each of structures 701, 702, and 703 include respective through holes 704, 705, and 706, each having a circular cross-sectional configuration. FIG. 7b illustrates that structures 701, 702, and 703 can be aligned such that through holes 704, 705, and 706 are in alignment and configured to receive a retaining pin there through.

FIG. 7c illustrates retaining pin 100 (as discussed above, and with reference to FIGS. 1-3d) inserted through the through holes 704-706 of structures 701-703 to initially interface with the structures prior to securing these together. Retaining pin 100 is shown in an unlocked state in FIG. 7c. As shown, shoulder 106 of retaining pin 700 comprises a larger cross-sectional diameter than through holes 704-706 and therefore engages with and seats against an outer surface 707 of structure 703, such that retaining pin 100 is held in place at a certain depth within and relative to the structures 701, 702, and 703. In FIG. 7c, a central axis of locking protrusion 104 is concentric or substantially concentric with a central axis of a tubular outer shaft of retaining pin 100. Accordingly, retaining pin 100 is readily slide-able in and out of structures 701, 702, and 703, with the structures 701, 702, and 703 not being fully locked in place or secured together.

FIG. 7d illustrates retaining pin 100 in the locked state within structures 701, 702, and 703, thus securing structures 701, 702, and 703 together. As shown, the handle of retaining pin 100 has been turned or rotated a predetermined degree to move locking protrusion 104 into a position eccentric with respect to tubular outer shaft 102 and rotatable shaft 110. The eccentricity of locking protrusion 104 relative to the rest of retaining pin 100 allows locking protrusion 104 to engage with an outer surface 708 of structure 702. Therefore, in the locked state, retaining pin 100 locks structures 701, 702, and 703 in place by interference and engagement between structure 702 and locking protrusion 104 as well as interference and engagement between structure 703 and shoulder 106 of retaining pin 100. In other words, structures 701, 702, and 703 are held between locking protrusion 104 and shoulder 106 of retaining pin 100 with locking protrusion 104 in a locked position.

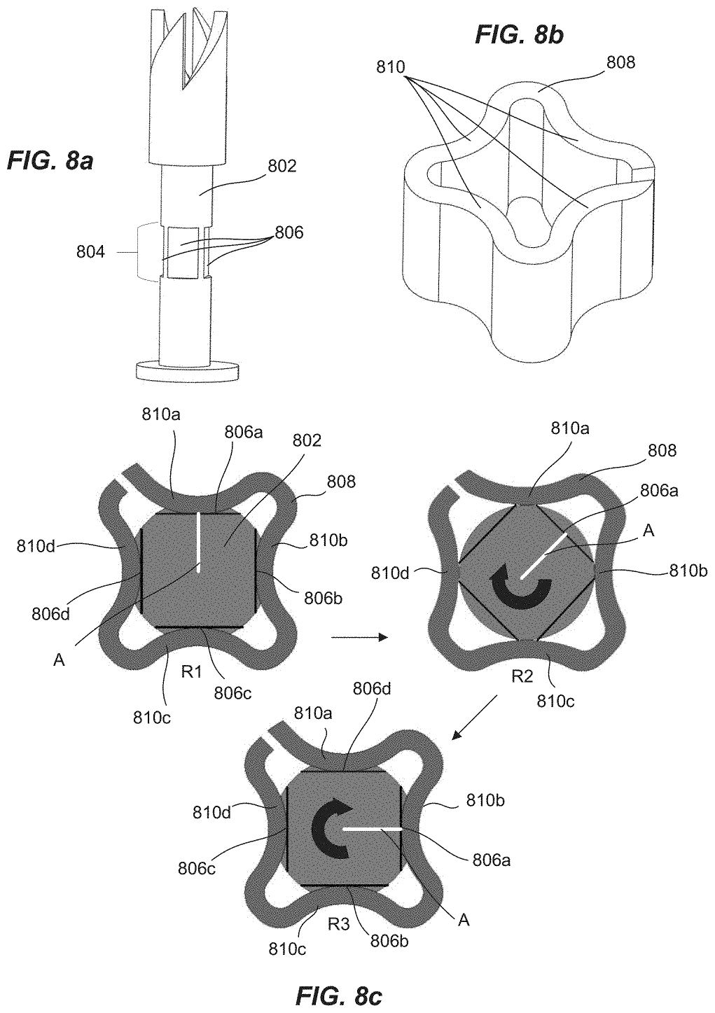

The function of the various positioning springs disclosed herein is discussed in more detail with reference to FIGS. 8a-8c. FIG. 8a illustrates a rotatable shaft 802 according to an example of the present disclosure. It is noted here that rotatable shaft 802 can represent and comprise any of the rotatable shafts discussed herein (e.g., rotatable shafts 110, 418, 618), regardless of the specific cam/follower surface configuration shown, which is similar to that of FIGS. 6a-6b, and that the feature of detent portion 804 discussed below can be present on any of the rotatable shafts discussed herein (e.g., rotatable shafts 110, 418, 618). As shown in this example, rotatable shaft 802 can comprise a detent portion 804 where one or more detent surfaces 806 can be formed in the outer surface of annular rotatable shaft 802. A positioning spring 808, as illustrated in FIG. 8b can be disposed around rotatable shaft 802, and positioned so as to be adjacent to and to surround detent portion 804 of rotatable shaft 802 where positioning spring 808 can engage detent surface 806 upon certain or select rotations of rotatable shaft 802. In the example shown, positioning spring 808 can be compliant and can comprise one or more compliant lobes 810 configured to engage with detent surfaces 806. In other words, detent surfaces 806 can be configured to receive and engage at least one of compliant lobes 810 depending upon the configuration and the desired rotation of rotatable shaft 802 to lock and unlock the retaining pin with which it is associated, as taught herein.

FIG. 8c illustrates three cross-sectional views of rotatable shaft 802 with positioning spring 810 rotatably engaged with the detent portion 804 of rotatable shaft 802. FIG. 8c illustrates three rotational positions or orientations R1, R2, and R3 of rotatable shaft 802 within and as engaged with positioning spring 808 as rotatable shaft rotates relative to the positioning spring 808.

As shown in angular orientation R1, indicator line A (used for clarity purposes to indicate the position of detent surface 806a) indicates that rotatable shaft 802 is oriented with respect to positioning spring 808, such that compliant lobe 810a is engaged with and seated against detent surface 806a, compliant lobe 810b is engaged with and seated against detent surface 806b, compliant lobe 810c is engaged with and seated against detent surface 806c, and compliant lobe 810d is engaged with and seated against detent surface 806d, with this R1 angular orientation illustrating a first clocking position of rotatable shaft 802 as facilitated by positioning spring 808. As shown, the distance from a center of rotatable shaft 802 to detent surfaces 806a-806d is less than a distance from the center of rotatable shaft 802 to the annular outer surface of rotatable shaft 802. In this R1 orientation, the compliance of positioning spring 808 causes a force to be exerted on detent surfaces 806a-806d by compliant lobes 810a-810d, respectively. Thereby, rotation of rotatable shaft 802 is resisted by positioning spring 808 and rotatable shaft 802 is biased to be held in the angular orientation R1, in which indicator line A is directed towards the compliant lobe 810a.

FIG. 8c further illustrates angular orientation R2 of rotatable shaft 802, with rotatable shaft 802 rotated, such that indicator line A is between compliant lobes 810a and 810b, and compliant lobes 810a-810d are each flexed and unseated from one of the detent surfaces 806a-806d. In this intermediate angular orientation R2, rotatable shaft 802 is out of a clocked position (i.e., a rotational position or orientation of the rotatable shaft with the positioning spring in a least flexed state). Indeed, when sufficient force is applied to rotate rotatable shaft 802 (e.g., via the handle of the retaining pin, not shown), rotatable shaft 802 rotates within positioning spring 808. As rotation is effectuated, compliant lobes 810a-810d are caused to flex outward as detent surfaces 806a-806d rotate in and out of position or alignment with compliant lobes 810a-810d, respectively, and as the opposing outer edges of detent surfaces 806a-806d push against compliant lobes 810a-810d, thus flexing positioning spring 808. As shown, detent surfaces 806a-806d are sized and configured to extend between different points on the outer surface of rotatable shaft 802. Moreover, compliant lobes 810a-810d can be configured (e.g., curved in this example) such that they provide what is essentially a line contact with detent surfaces 806a-806d, respectively, such that rotation of rotatable shaft 802 causes compliant lobes 810a-810d to slide along detent surfaces 806a-806d, respectively, where they are caused to flex outwardly to accommodate such rotation of rotatable shaft 802. In this intermediate position R2, compliant lobes 810a-810d are not engaged with detent surfaces 806a-806d.

FIG. 8c further illustrates angular orientation R3, which illustrates the rotatable shaft 802 in a clocked position 90 degrees from the clocked position of angular orientation R1. In angular orientation R3, rotation of rotatable shaft 802 has been sufficient to cause compliant lobes 810a-810d to spring back to their original pre-flexed position such that compliant lobes 810a-810d are each engaged with and seated against one of the detent surfaces 806a-806d. In this docked position, compliant lobe 810a is engaged with and seated against detent surface 806d, compliant lobe 810b is engaged with and seated against detent surface 806a, and so on as shown. By this engagement, rotatable shaft 802 is held in a new angular orientation R3 where each detent surface is engaged with a different compliant lobe. The compliance of positioning spring 808 holds compliant lobes 810 against respective detent surfaces 806 to resist rotation of rotatable shaft 802 and to bias rotatable shaft 802 in a clocked position, as shown in angular orientation R3.

The positioning spring 808 shown allows for rotatable shaft to be biased at four different radial and clocked positions, each spaced 90 degrees apart. However, this is not intended to be limiting in any way, and those skilled in the art will recognize that other radial and clocking positions are possible and contemplated herein, depending upon the design and configuration of the rotatable shaft and the positioning spring associated therewith. Indeed, positioning spring can have any number of one or more compliant lobes configured to engage with any number of one or more detent surfaces of the rotatable shaft. Additionally, the positioning spring can have a number of compliant lobes equal to a number of detent surfaces or can have a number of compliant lobes different then the number of detent surfaces. Additionally, the compliant lobes and detent surfaces can be spaced at any angle around the positioning spring and rotatable shaft.

It is noted that the clocking positions of any of rotatable shafts 418, 618 and 802 can be offset with respect to the cam and follower surfaces of the plunger shafts (e.g., plunger shafts 408, 608) and rotatable shafts, respectively, with which they are associated with, such that upon release of a plunger shaft, and disengagement of the cam surfaces from the follower surfaces the positioning spring associated with a rotatable shaft induces an additional degree of rotation sufficient to align the cam surfaces of the plunger shaft with different follower surfaces of the rotatable shaft, thus facilitating successive rotation of the rotatable shaft upon each depression of the plunger shaft. In other words, with the plunger shaft fully depressed, this results in rotation of the rotatable shaft to a position just short of a clocked position. As the plunger shaft is released such that each of the cam surfaces disengage from their respective current follower surface, the positioning spring causes the rotatable shaft to rotate an additional amount of rotation where the rotatable shaft is now in a clocked position, and different follower surfaces are caused to be aligned with different cam surface of the plunger shaft, such that subsequent depression of the plunger shaft causes each of the individual cam surfaces to engage a different follower surface of the available follower surfaces, and to further rotate the rotatable shaft.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Although the disclosure may not expressly disclose that some embodiments or features described herein can be combined with other embodiments or features described herein, this disclosure should be read to describe any such combinations that would be practicable by one of ordinary skill in the art. The use of “or” in this disclosure should be understood to mean non-exclusive or, i.e., “and/or,” unless otherwise indicated herein.

Furthermore, the described features, structures, or characteristics can be combined in any suitable manner in one or more examples. In the preceding description, numerous specific details were provided, such as examples of various configurations to provide a thorough understanding of examples of the described technology. It will be recognized, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A retaining pin, comprising:
a tubular outer shaft; and
a rotatable shaft disposed within the tubular outer shaft, and rotatably engaged with the tubular outer shaft, the rotatable shaft comprising a locking protrusion fixed to an end of the rotatable shaft and that is operable to rotate with rotation of the rotatable shaft;
wherein an axis of the tubular outer shaft and an axis of the rotatable shaft are eccentric.

2. The retaining pin of claim 1, further comprising a positioning spring configured to rotatably engage with the rotatable shaft that is configured to rotate relative to the positioning spring;
wherein the rotatable shaft comprises one or more detent surfaces configured to receive one or more compliant lobes of the positioning spring to resist rotation of the rotatable shaft and to bias the rotatable shaft in respective angular orientations and corresponding clocked positions.

3. The retaining pin of claim 1, wherein the locking protrusion is eccentric with the axis of the rotatable shaft.

4. The retaining pin of claim 3, wherein the retaining pin is configured to be operable in both an unlocked state corresponding to a first angular orientation and corresponding clocked position of the rotatable shaft and a locked state corresponding to a second angular orientation and corresponding clocked position of the rotatable shaft;
wherein, in the unlocked state the locking protrusion is substantially concentric with the tubular outer shaft; and
wherein, in the locked state the locking protrusion is eccentric with the tubular outer shaft, such that at least a portion of the locking protrusion extends outside of a perimeter of the tubular outer shaft and is operable to lock the retaining pin in place by engagement of the locking protrusion with a structure in support of the retaining pin.

5. The retaining pin of claim 1, further comprising a rotatable handle fixed to the rotatable shaft and configured to facilitate rotation of the rotatable shaft by rotation of the rotatable handle.

6. The retaining pin of claim 1, further comprising:
a plunger comprising a plunger shaft having a cam surface that interfaces with a follower surface of the rotatable shaft;
wherein the cam surface of the plunger shaft engages with the follower surface of the rotatable shaft such that depressing the plunger in a linear motion rotates the rotatable shaft.

7. The retaining pin of claim 6, wherein the cam surface of the plunger shaft comprises a helically-angled surface at an engagement end of the plunger shaft, and the follower surface of the rotatable shaft comprises a helically-angled surface that engages with the helically-angled surface of the cam surface of the plunger shaft.

8. The retaining pin of claim 1, further comprising one or more roller bearings supported by the tubular outer shaft;
wherein the rotatable shaft is rotatably engaged with the tubular outer shaft by rotatable engagement with the one or more roller bearings supported by the tubular outer shaft.

9. The retaining pin of claim 8, wherein the one or more roller bearings comprise:
a first sealed roller bearing disposed at a first opening of the tubular outer shaft; and
a second sealed roller bearing disposed at a second opening of the tubular outer shaft;
wherein the rotatable shaft is rotatably engaged with the first and second sealed roller bearings; and
wherein the tubular outer shaft is sealed from an outside environment and foreign object debris by the first and second sealed roller bearings.

10. The retaining pin of claim 6, wherein the plunger is spring-loaded.

11. The retaining pin of claim 6, wherein a single depression and release of the plunger rotates the rotatable shaft by a predetermined angle of rotation.

12. The retaining pin of claim 11, wherein the predetermined angle of rotation resulting from the single press of the plunger facilitates rotation of the rotatable shaft from the first angular orientation associated with the unlocked state to the second angular orientation associated with the locked state.

13. The retaining pin of claim 11, wherein the predetermined angle of rotation resulting from the single press of the plunger facilitates rotation of the rotatable shaft from the second angular orientation associated with the locked state to the first angular orientation associated with the unlocked state.

14. The retaining pin of claim 4, further comprising a positioning spring engaged with the rotatable shaft to facilitate rotation of the rotatable shaft relative to the positioning spring;
wherein the rotatable shaft comprises one or more detent surfaces configured to receive one or more compliant lobes of the positioning spring to resist rotation of the rotatable shaft and to retain the rotatable shaft at one or more clocked positions;
wherein at least one of the one or more detent surfaces corresponds to a first clocked position of the rotatable shaft corresponding to the unlocked state; and
wherein at least one of the one or more detent surfaces corresponds to a second clocked position of the rotatable shaft corresponding to the locked state.

15. The retaining pin of claim 4, wherein the locking protrusion is a disk that is eccentrically fixed to the rotatable shaft;
wherein, in the unlocked position, the disk is substantially concentric with respect to the axis of the tubular outer shaft;
wherein, in the locked position, the disk is eccentric with respect to the axis of the tubular outer shaft.

16. The retaining pin of claim 4, wherein the locking protrusion is a disk that is eccentrically fixed to the rotatable shaft;
wherein, in the unlocked position, an outer surface of the disk is substantially aligned with an outer surface of the tubular outer shaft;
wherein, in the locked position, the outer surface of the disk is out of alignment with respect to the outer surface of the tubular outer shaft such that a portion of the disk overhangs the outer surface of the tubular outer shaft.

17. A method for configuring a retaining pin, comprising:
configuring the retaining pin to comprise a tubular outer shaft;
configuring the retaining pin to comprise a rotatable shaft disposed within the tubular outer shaft, and rotatably engaged with the tubular outer shaft, the rotatable shaft comprising a locking protrusion fixed to an end of the rotatable shaft and that is operable to rotate with rotation of the rotatable shaft;
wherein an axis of the tubular outer shaft and an axis of the rotatable shaft are eccentric.

18. The method of claim 17, further comprising:
configuring the retaining pin to comprise a rotatable handle fixed to the rotatable shaft and configured to facilitate rotation of the rotatable shaft by rotation of the rotatable handle.

19. The method of claim 17, further comprising:
configuring the retaining pin to comprise a plunger comprising a cam surface that interfaces with a follower surface of the rotatable shaft;
wherein the cam surface of the plunger engages with the follower surface of the rotatable shaft such that depressing the plunger in a linear motion rotates the rotatable shaft.

20. A system, comprising:
a first structure comprising a hole formed through the first structure;
a second structure comprising a hole formed through the second structure; and
a retaining pin comprising:
a tubular outer shaft; and
a rotatable shaft disposed within the tubular outer shaft, and rotatably engaged with the tubular outer shaft, the rotatable shaft comprising a locking protrusion fixed to the rotatable shaft and that is operable to rotate with rotation of the rotatable shaft;
wherein an axis of the tubular outer shaft and an axis of the rotatable shaft are eccentric, and wherein the locking protrusion is eccentric with the axis of the rotatable shaft;
wherein the first structure is configured to be coupled to the second structure by the retaining pin inserted through the hole of the first structure and the hole of the second structure, the locking protrusion being engaged with a surface of one or more of the first structure and the second structure.
